(19) United States
(12) Patent Application Publication
(10) Pub. No.: US 2024/0356873 A1
(43) Pub. Date: Oct. 24, 2024

(54) PERSONAL AI INTENT UNDERSTANDING

(71) Applicants: Jason Brewer, Mountain View, CA (US); Wenxiang Chen, San Jose, CA (US); Michael James Cunningham, Brooklyn, NY (US); Dmytro Ishchenko, Los Angeles, CA (US); Tanvi Motwani, Mountain View, CA (US); Diwakar Punjani, Las Altos, CA (US)

(72) Inventors: Jason Brewer, Mountain View, CA (US); Wenxiang Chen, San Jose, CA (US); Michael James Cunningham, Brooklyn, NY (US); Dmytro Ishchenko, Los Angeles, CA (US); Tanvi Motwani, Mountain View, CA (US); Diwakar Punjani, Las Altos, CA (US)

(21) Appl. No.: 18/639,447

(22) Filed: Apr. 18, 2024

Related U.S. Application Data
(60) Provisional application No. 63/496,858, filed on Apr. 18, 2023.

(51) Int. Cl. H04L 51/02; H04L 51/216

(52) U.S. Cl. CPC H04L 51/02; H04L 51/216

(57) ABSTRACT

A chatbot system for an interactive platform. The chatbot system receives a prompt from a user and determines an intent of the user using the prompt. If the chatbot system can't determine an intent, the chatbot communicates the prompt as a personality prompt to a generative AI model. If the chatbot system can determine an intent from the prompt, the chatbot system generates an API call to an additional service using the intent. The chatbot system uses values returned by the additional service to generate a hint prompt that is communicated to the generative AI model. The chatbot system receives a response from the generative AI model to the personality prompt or hint prompt and communicates the response to the user.

### TECHNICAL FIELD

The present disclosure relates generally to interactive platforms and more particularly to providing interaction interfaces to users of an interactive platform.

### BACKGROUND

Users enjoy accessing interactive platforms to share content with other users of the interactive platform. In addition, users often enjoy interacting with a chatbot.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a machine in the form of a computer system within which a set of instructions may be executed to cause the machine to perform any one or more of the methodologies discussed herein, according to some examples.

FIG. 3 is a block diagram of a chatbot system in accordance with some examples.

FIG. 4A is a process flow diagram of a generative AI model prompting method, in accordance with some examples.

FIG. 4B is a collaboration diagram of the operations of a chatbot system, in accordance with some examples,

FIG. 5 is an illustration of a chat session between a user and a chatbot, in accordance with some examples.

FIG. 6 illustrates a machine-learning pipeline, according to some examples.

FIG. 7 illustrates training and use of a machine-learning program, according to some examples.

FIG. 8 is a diagrammatic representation of a data structure as maintained in a database, according to some examples.

FIG. 9 is a diagrammatic representation of a message, according to some examples.

FIG. 10 is a flowchart for an access-limiting process, according to some examples.

FIG. 11 is a diagrammatic representation of a messaging system, according to some examples, that has both client-side and server-side functionality.

FIG. 12 is a block diagram showing a software architecture within which examples may be implemented.

### DETAILED DESCRIPTION

Interactive platforms (e.g., interaction systems, social platforms, social media platforms, AR platforms, applications, messaging platforms, AR applications, operating systems, gaming systems or applications, systems with which a user interacts, and the like) may provide a way for users to interact with other users. For some users, interaction with an interactive platform may be enhanced by having a chatbot to interact with. The chatbot can serve multiple uses, including providing a way for a user obtain information. The more accurate the information is, the more useful that information is to a user.

In some examples, a chatbot system determines prompt types and routes them accordingly to improve conversation quality. The chatbot system analyzes user prompts and identifies personality versus intent prompts. Personality prompts are passed to a generative model for open-ended responses, while intent prompts generate API calls to fetch situational information for constructing informed responses. This allows the chatbot system to have both engaging chitchat and provide useful details.

In some examples, a chatbot system integrates external services by making API calls based on prompt intents. The chatbot system extracts intents from user prompts and formulates API calls to platform services using those intents. It gathers relevant data from these API calls to generate hint prompts that lead to more informative responses. This allows the chatbot system to tap into contextual data sources for responding appropriately.

In some examples, a chatbot system handles multimodal inputs like audio, images, and video for versatile conversations. The chatbot system can process prompts containing varied media types such as audio clips, pictures, videos, and text. This allows the chatbot system to understand intents expressed through different modalities and have richer interactions.

In some examples, a chatbot system personalizes conversations by utilizing user profiles and chat history. The chatbot system determines user intents based on profiles with preferences and past interactions. It also maintains conversation state across sessions. This context allows the chatbot system to interpret prompts more accurately and have more natural, personalized dialogues.

In some examples, a chatbot system improves continuously through feedback and usage data. The chatbot system collects real user prompts and responses to refine its natural language understanding and dialogue components via machine learning. Increased interactions provide more data to enhance its models. This allows the chatbot system to incrementally improve its conversational abilities.

In some examples, a chatbot system adopts a modular architecture for flexibility. The chatbot system utilizes separate components for NLU, dialogue management, and response generation. This modular design allows the chatbot system to swap out components, tap different external AI models, and add enhancements more easily.

In some examples, a chatbot system filters inappropriate responses before sending. The chatbot system passes generated responses through a filtering component to catch offensive or harmful language. This allows the chatbot system to improve the appropriateness of its responses.

Other technical features may be readily apparent to one skilled in the art from the following figures, descriptions, and claims.

### Networked Computing Environment

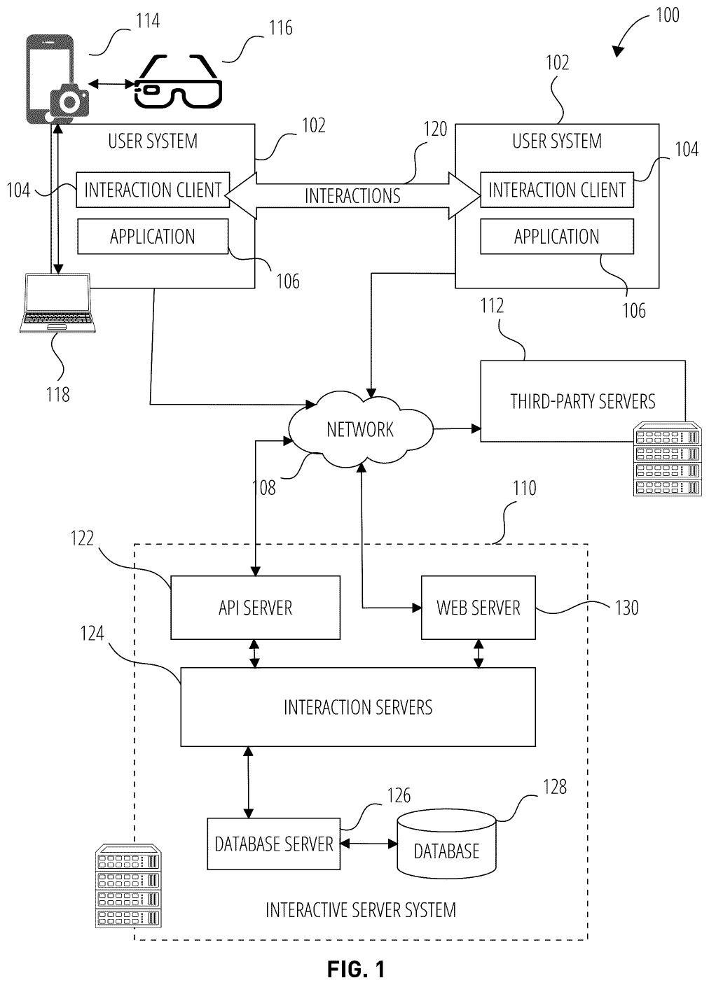

FIG. 1 is a block diagram showing an example interactive platform 100 of an interactive platform for facilitating interactions (e.g., exchanging text messages, conducting text audio and video calls, or playing games) over a network. The interactive platform 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interactive server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the interactive server system 110 via the network 108. The data exchanged between the interaction clients 104 (e.g., interactions 120) and between the interaction clients 104 and the interactive server system 110 includes functions (e.g., commands to invoke functions) and payload data (e.g., text, audio, video, or other multimedia data).

The interactive server system 110 provides server-side functionality via the network 108 to the interaction clients 104. While certain functions of the interactive platform 100 are described herein as being performed by either an interaction client 104 or by the interactive server system 110, the location of certain functionality either within the interaction client 104 or the interactive server system 110 may be a design choice. For example, it may be technically preferable to initially deploy particular technology and functionality within the interactive server system 110 but to later migrate this technology and functionality to the interaction client 104 where a user system 102 has sufficient processing capacity.

The interactive server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, interactive platform information, and live event information. Data exchanges within the interactive platform 100 are invoked and controlled through functions available via user interfaces (UIs) of the interaction clients 104.

Turning now specifically to the interactive server system 110, an Application Program Interface (API) server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the interaction servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the interaction servers 124. The Application Program Interface (API) server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity graph (e.g., a social graph); the location of friends within a social graph; and opening an application event (e.g., relating to the interaction client 104).

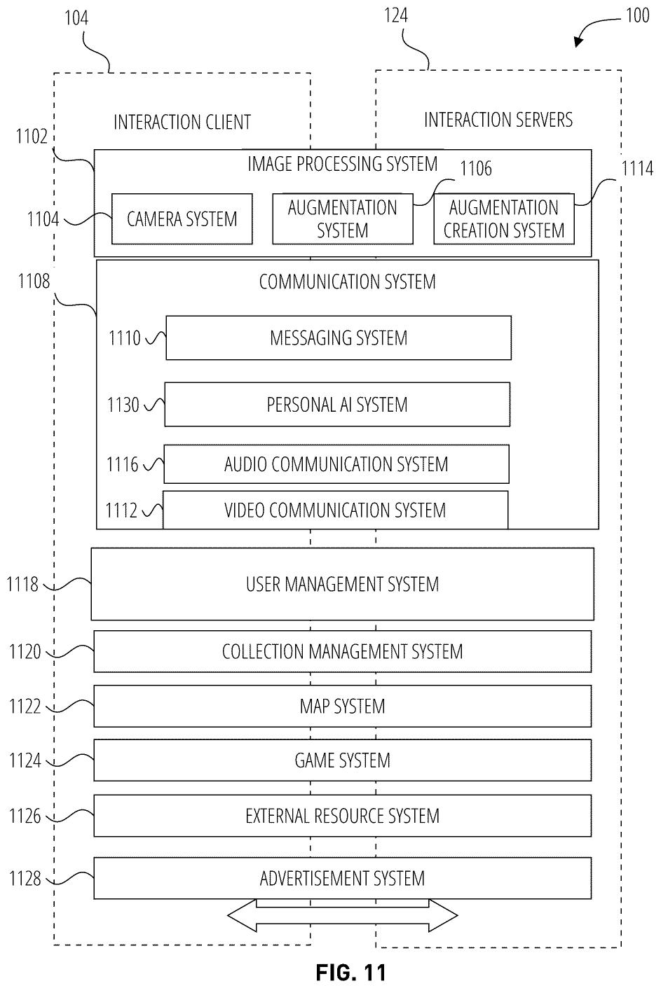

The interaction servers 124 host multiple systems and subsystems, described below with reference to FIG. 11.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a.*ml file), an applet may incorporate a scripting language (e.g., a.*js file or a .json file) and a style sheet (e.g., a.*ss file).

In response to receiving a user selection of the option to launch or access features of the external resource, the interaction client 104 determines whether the selected external resource is a web-based external resource or a locally-installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from a third-party server 112 for example, a markup-language document associated with the small-scale application and processing such a document.

In response to determining that the external resource is a locally-installed application 106, the interaction client 104 instructs the user system 102 to launch the external resource by executing locally-stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently-used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface).

### Machine Architecture

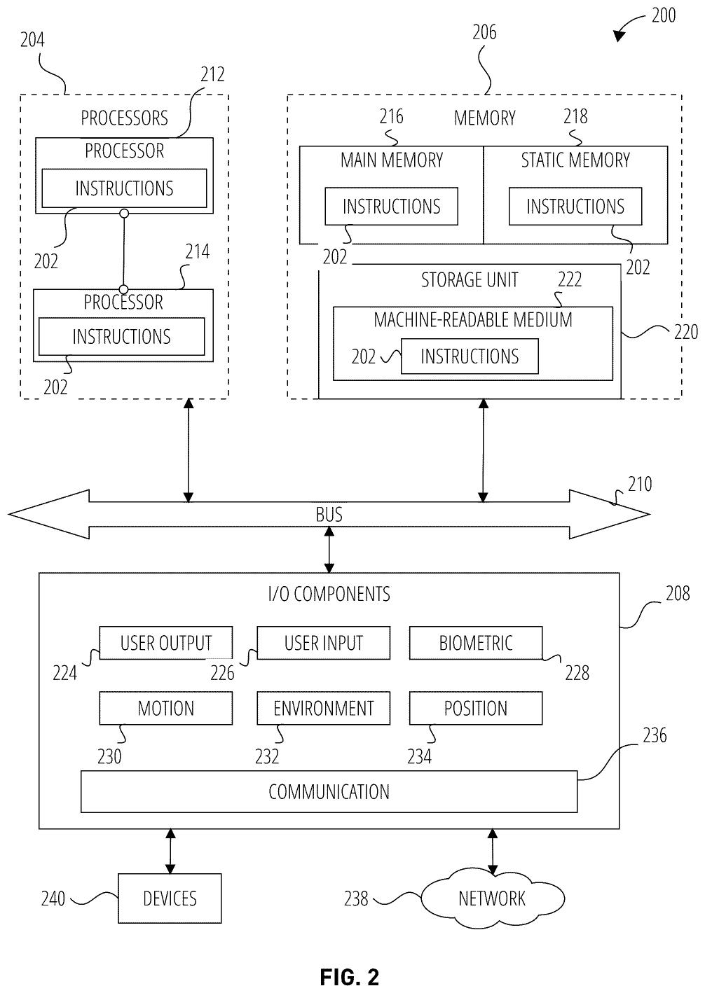

FIG. 2 is a diagrammatic representation of the machine 200 within which instructions 202 (e.g., software, a program, an application, an applet, an app, or other executable code) for causing the machine 200 to perform any one or more of the methodologies discussed herein may be executed. For example, the instructions 202 may cause the machine 200 to execute any one or more of the methods described herein. The instructions 202 transform the general, non-programmed machine 200 into a particular machine 200 programmed to carry out the described and illustrated functions in the manner described. The machine 200 may operate as a standalone device or may be coupled (e.g., networked) to other machines. In a networked deployment, the machine 200 may operate in the capacity of a server machine or a client machine in a server-client network environment, or as a peer machine in a peer-to-peer (or distributed) network environment. The machine 200 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 202, sequentially or otherwise, that specify actions to be taken by the machine 200. Further, while a single machine 200 is illustrated, the term “machine” shall also be taken to include a collection of machines that individually or jointly execute the instructions 202 to perform any one or more of the methodologies discussed herein. The machine 200, for example, may comprise the user system 102 or any one of multiple server devices forming part of the interactive server system 110. In some examples, the machine 200 may also comprise both client and server systems, with certain operations of a particular method or algorithm being performed on the server-side and with certain operations of the particular method or algorithm being performed on the client-side.

The machine 200 may include processors 204, memory 206, and input/output I/O components 208, which may be configured to communicate with each other via a bus 210. In an example, the processors 204 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 212 and a processor 214 that execute the instructions 202. The term “processor” is intended to include multi-core processors that may comprise two or more independent processors (sometimes referred to as “cores”) that may execute instructions contemporaneously. Although FIG. 2 shows multiple processors 204, the machine 200 may include a single processor with a single-core, a single processor with multiple cores (e.g., a multi-core processor), multiple processors with a single core, multiple processors with multiples cores, or any combination thereof.

The memory 206 includes a main memory 216, a static memory 218, and a storage unit 220, both accessible to the processors 204 via the bus 210. The main memory 206, the static memory 218, and storage unit 220 store the instructions 202 embodying any one or more of the methodologies or functions described herein. The instructions 202 may also reside, completely or partially, within the main memory 216, within the static memory 218, within machine-readable medium 222 within the storage unit 220, within at least one of the processors 204 (e.g., within the processor's cache memory), or any suitable combination thereof, during execution thereof by the machine 200.

The I/O components 208 may include a wide variety of components to receive input, provide output, produce output, transmit information, exchange information, capture measurements, and so on. The specific I/O components 208 that are included in a particular machine will depend on the type of machine. For example, portable machines such as mobile phones may include a touch input device or other such input mechanisms, while a headless server machine will likely not include such a touch input device. It will be appreciated that the I/O components 208 may include many other components that are not shown in FIG. 2. In various examples, the I/O components 208 may include user output components 224 and user input components 226. The user output components 224 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 226 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 208 may include biometric components 228, motion components 230, environmental components 232, or position components 234, among a wide array of other components. For example, the biometric components 228 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 230 include acceleration sensor components (e.g., accelerometer), gravitation sensor components, rotation sensor components (e.g., gyroscope). The biometric components may include a brain-machine interface (BMI) system that allows communication between the brain and an external device or machine. This is achieved by recording brain activity, translating it into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which involve surgically implanting electrodes directly into the brain.
Optogenetics BMIs, which use light to control the activity of specific nerve cells in the brain.
Functional magnetic resonance imaging (fMRI)-based BMIs, which use magnetic fields to measure blood flow in the brain, which can be used to infer brain activity.

The environmental components 232 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 234 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 208 further include communication components 236 operable to couple the machine 200 to a network 238 or devices 240 via respective coupling or connections. For example, the communication components 236 may include a network interface component or another suitable device to interface with the network 238. In further examples, the communication components 236 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 240 may be another machine or any of a wide variety of peripheral devices (e.g., a peripheral device coupled via a USB).

Moreover, the communication components 236 may detect identifiers or include components operable to detect identifiers. For example, the communication components 236 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 236, such as location via Internet Protocol (IP) geolocation, location via Wi-Fi® signal triangulation, location via detecting an NFC beacon signal that may indicate a particular location, and so forth.

The various memories (e.g., main memory 216, static memory 218, and memory of the processors 204) and storage unit 220 may store one or more sets of instructions and data structures (e.g., software) embodying or used by any one or more of the methodologies or functions described herein. These instructions (e.g., the instructions 202), when executed by processors 204, cause various operations to implement the disclosed examples.

The instructions 202 may be transmitted or received over the network 238, using a transmission medium, via a network interface device (e.g., a network interface component included in the communication components 236) and using any one of several well-known transfer protocols (e.g., hypertext transfer protocol (HTTP)). Similarly, the instructions 202 may be transmitted or received using a transmission medium via a coupling (e.g., a peer-to-peer coupling) to the devices 240.

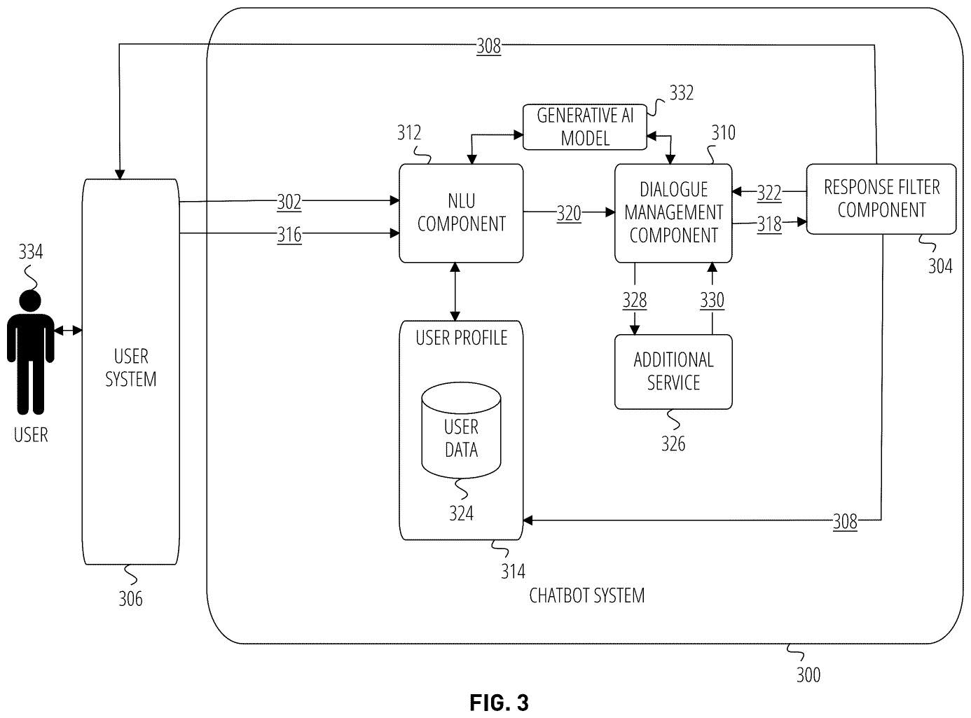

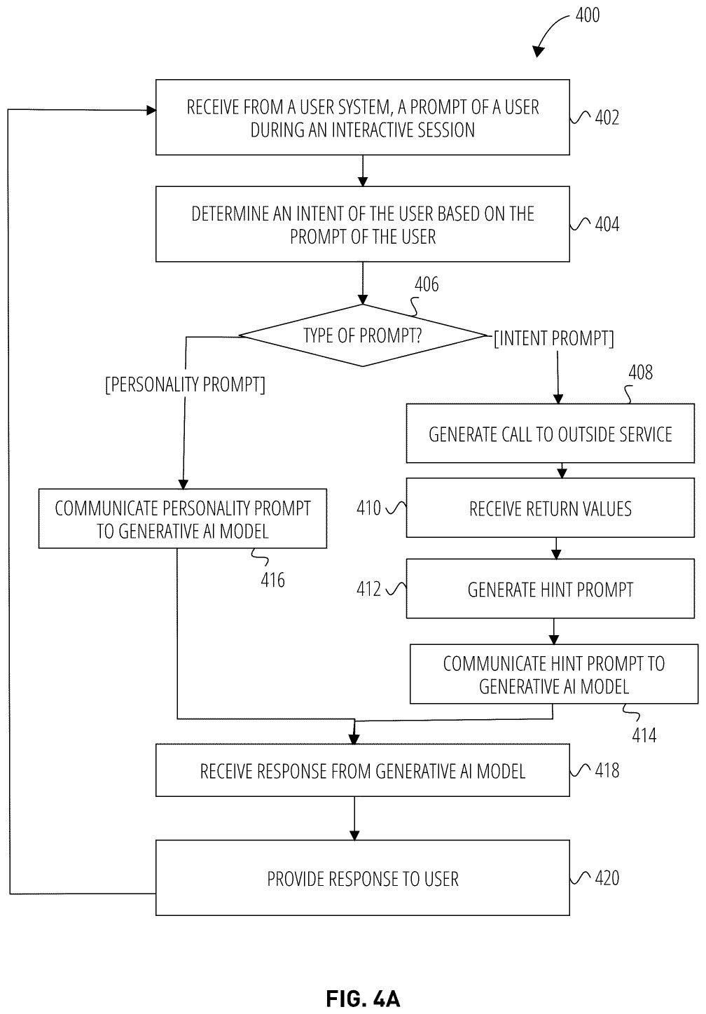

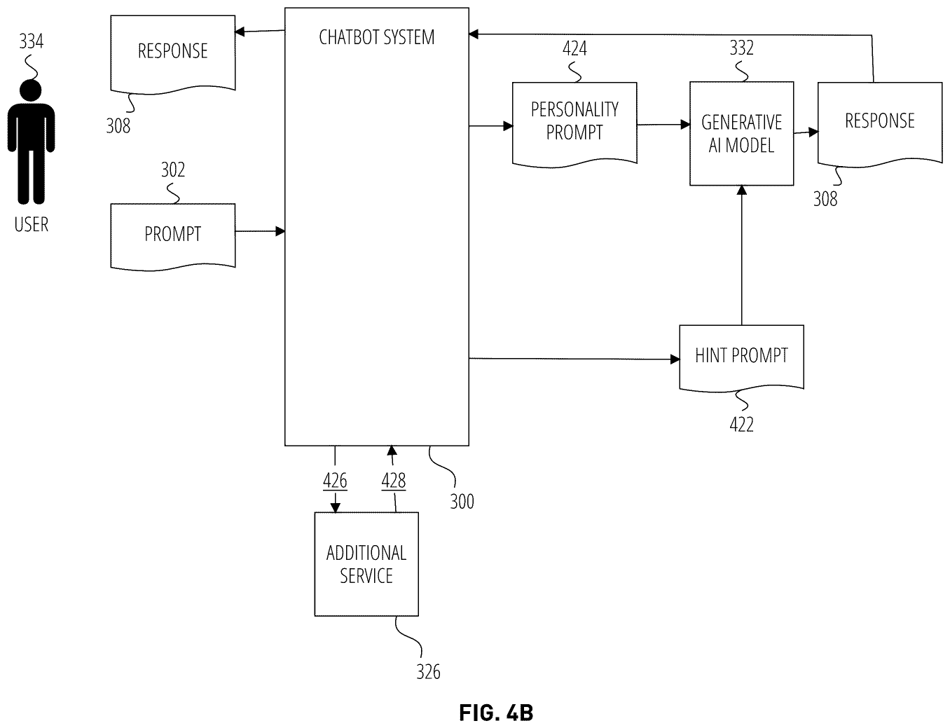

FIG. 3 is a block diagram of a chatbot system 300 and FIG. 4A is a process flow diagram of a chatbot system 300 between a user 334 and the chatbot system 300, in accordance with some examples. A chatbot system 300 uses the chatbot system 300 to conduct a chat session with user 334 during an interactive session.

Although the example chatbot system 300 depicts a particular sequence of operations, the sequence may be altered without departing from the scope of the present disclosure. For example, some of the operations depicted may be performed in parallel or in a different sequence that does not materially affect the function of the chatbot system 300. In other examples, different components of an example device or system that implements the chatbot system 300 may perform functions at substantially the same time or in a specific sequence.

In some examples, the chatbot system 300 is a software platform designed to simulate human conversation through voice commands or text chats. The chatbot system 300 may employ natural language processing (NLP) and machine learning (ML)/artificial intelligence methodologies to understand and interpret the input of the user 334 and generate a response 308.

In some examples, the chatbot's architecture comprises one or more natural language understanding (NLU) components, such as NLU component 312, and one or more dialogue management components, such as dialogue management component 310. The NLU component 312 is responsible for understanding an intent 320 of the user 334 and extracting relevant information from the input of the user, such as prompt 302. This is achieved by analyzing the prompt 302 and mapping it to an intent. The NLU component 312 can use various methodologies such as rule-based systems, statistical models, Large Language Models (LLMs), neural networks, and the like to understand the input of the user. The dialogue management component 310 generates a response 308 to the input of the user. The dialogue management component 310 uses the intent 320 and any extracted information from the NLU component 312 to determine the appropriate response 308. This can be done using rule-based systems, decision trees, statistical models, generative AI models, neural networks, and the like. In some examples, the NLU component 312 and the dialogue management component 310 are a single component.

Once the NLU component 312 extracts the relevant information from the prompt 302 as an intent 320 of the user 334, the dialogue management component 310 receives an appropriate response 308. The dialogue management component 310 generates responses in a human-like manner by using methodologies such as, but not limited to, text generation and machine learning models.

In some examples, either the NLU component 312 or the dialogue management component 310 may use a generative AI model 332 such as, but not limited to, an LLM or the like, to improve their natural language understanding and dialogue management capabilities. For example, the NLU component 312 uses the generative AI model 332 to analyze the input of the user and extract relevant information, such as the intent of the user and entities. The dialogue management component 310 can also use the generative AI model 332 to identify and extract important information from unstructured text, such as a question of the user or a request. This can be done using methodologies such as named entity recognition, part-of-speech tagging, sentiment analysis, and the like. In some examples, the NLU component 312 communicates the prompt 302 directly to the generative AI model 332. The generative AI model 332 receives the prompt 302 and generates the response 308. In a similar mater, the dialogue management component 310 may receive the intent 320 and generate a prompt that is communicated to the generative AI model 332. The generative AI model 332 receives the prompt and generates the response 308.

FIG. 4A is a process flow diagram of a generative AI model prompting method, and FIG. 4B is a collaboration diagram of the operations of a chatbot system, in accordance with some examples. A chatbot system, such as chatbot system 300 (of FIG. 3), uses a generative AI model prompting method 400 to generate personality prompts and hint prompts for a generative AI model 332 (of FIG. 3).

In operation 402, the chatbot system 300 receives, via a user system 306 (of FIG. 3), a prompt 302 of a user 334 during an interactive session. For example, the user 334 uses user system 306 to access an interactive platform that hosts the chatbot system 300. The user 334 enters a prompt 302 into the user system 306 and the user system 306 communicates the prompt 302 to the chatbot system 300. In some examples, the prompt 302 may include other types of data as well as text such as, but not limited to, image data, video data, audio data, electronic documents, links to data stored on the Internet or the user system 306, and the like. In addition, the prompt 302 may include media such as, but not limited to, audio media, image media, video media, textual media, and the like. Regardless of the data type of the prompt 302, keyword attribution and expansion may be used to automatically generate a cluster of keywords or attributes that are associated with the received prompt 302. For example, image recognition may be deployed to identify objects and location associated with visual media and image data and to generate a keyword cluster or cloud that is then associated with the image-based prompt.

The prompt 302 may furthermore be received through any number of interfaces and I/O components (e.g., the I/O components 208) of a user system 102. These include gesture-based inputs obtained from a biometric component and inputs received via a Brain-Computer Interface (BCI).

In some examples, the chatbot system 300 is integrated into various platforms such as, but not limited to, websites, messaging apps, and mobile apps, allowing users to interact with it through text or voice commands.

In operation 404, the chatbot system 300 determines an intent 320 (of FIG. 3) of the user 334 using the user prompt 302. For example, an NLU component 312 (of FIG. 3) receives the prompt 302 and any user feedback 316 comprising follow up messages from the user 334 and uses an intent processing pipeline to determine the intent 320. This pipeline uses Natural Language Processing (NLP) methodologies to map sets of conversations to a bag of intentful keywords and concepts. In addition to the keywords that are used in the original prompt 302, stemmed keywords and expanded concepts are also generated. The platform also assigns a weight to each concept based on the importance of those in the conversation. These keywords and concepts are aggregated and mapped to the user 334 as part of an intent profile or intent vector having weighted keywords and concepts based on the importance of those in the conversation.

In some examples, the chatbot system 300 associates a time factor to a keyword or concept where the time factor decays in time. For example, the chatbot system 300 attaches a time factor to the keywords and concepts, which indicates how fresh that concept should be used for targeting and bidding. For example, “Hotels in Cancun for spring break” vs “Planning for wedding next year” will have two different decaying factors. In some examples, the chatbot system 300 applies a time factor to a conversation state.

In some examples, an overall intent of the user is built using various signals or data such as user demographics, location, device, engagement with organic surfaces that are user interface and service features provided by the interactive of an interactive platform application and consumption patterns, and overall friend-graph proximity carrier signals or data that may be discernable from the user's affiliation with the interactive platform.

In some examples, the intent vector is an additional dimension that will be used to refresh and update an intent profile stored in a user profile 314 (of FIG. 3).

In some examples, the chatbot system 300 uses the user profile 314 that includes interactive platform user data 324 (of FIG. 3) of the user 334 to determine an intent of the user.

In some examples, the NLU component 312 (of FIG. 3) uses artificial intelligence methodologies including Machine Learning (ML) models to generate the intent 320. The chatbot system 300 uses the data on intent of the user and conversation context to improve its responses and optimization capabilities over time by ingesting the feedback. The chatbot system 300 collects engagement of the user 334 on ads, organic surfaces (user interfaces and services provided to users by the interactive platform) features of the interactive platforming system and also responses to the chatbot system 300 itself and feeds that into the NLU component 312. Accordingly, the chatbot system 300 can finetune or further pre-train the ML models of the NLU component 312 to not only take intent of the user into consideration, but also use follow up actions to finetune the intent of the user inference model.

In some examples, the chatbot system 300 collects a set of prompts during an interactive session. The chatbot system 300 maps the set of prompts to a set of keywords and/or concepts comprising an intent vector, as exemplified by keywords and concepts. The chatbot system 300 assigns weights to the keywords of the set of keywords and/or concepts based on an importance score to the conversation of the keyword and/or concept, and determines the intent of the user based on the intent vector including the weighted keywords and/or concepts.

In some examples, the chatbot system 300 stores a conversation state in a user profile 314 as part of user data 324 of a series of interactive sessions so that the chatbot system 300 can have a context for conversations that occur over a plurality of interactive sessions.

In some examples, a knowledge base of the chatbot system 300 comprises a set of information that the chatbot can use to understand and respond to an input of the user. This includes, but is not limited to, a predefined set of intents, entities, and responses, as well as external sources of information such as databases or APIs. In some examples, intent information of a friend, or friends, of the user 334 are used to understand, inform, and/or respond to a user's intent.

In some examples, an intent may not be determinable from the prompt of the user. For example, they user may make a declarative statement when no previous chat history exists such as, but not limited to, making a declaration about they user's state, a declaration about a state of the user's immediate environment, or the like.

In operation 406, the chatbot system 300 determines a type of the prompt 302 using the prompt 302 and a chat history stored in the user profile 314. For example, if the chatbot system 300 cannot determine any keywords in the prompt 302 that have relevance to the chat history and none of the words in the prompt 302 have relevance to the chatbot system 300 or the interactive platform hosting the chatbot system 300, the chatbot system 300 determines a type of the prompt as being a personality prompt to be directly communicated to the generative AI model 332 (of FIG. 3) to prompt a response out of the generative AI model 332. However, if the chatbot system 300 determines one or more keywords in the prompt that have relevance to the chat history, relevance to the chatbot, or relevance to the interactive platform hosting the chatbot, the chatbot system 300 determines a type of the prompt 302 as being an intent prompt to be used to generate an API call to one or more services outside of the chatbot system 300.

In response to determining that the prompt is a personality prompt, in operation 416, the chatbot system 300 communicates the prompt 302 as a personality prompt 424 to the generative AI model 332.

In response to determining that the prompt 302 is an intent prompt from which a user intent can be determined, in operation 408, the chatbot system 300 generates one or more API calls 426 to one or more additional services 326 outside of the chatbot system 300. For example, the chatbot system 300 determines that one or more keywords reference a physical location, the chatbot system 300 will call a mapping service passing the one or more keywords as arguments to the mapping service. In some examples, the chatbot system 300 determines that the keywords are related to a service or feature of the interactive platform hosting the chatbot system 300 and make a call to that service or feature passing the one or more keywords as arguments to the service or feature.

In operation 410, the chatbot system 300 receives one or more return values 428 from the one or more additional services 326. For example, if the chatbot system 300 called a map service, the map service will return a physical location and information about the physical location. In some examples, if the chatbot system 300 called a service or feature of the interactive platform that hosts the chatbot system 300, the service or feature will return data generated by the service or information about the feature.

In operation 412, the chatbot system 300 generates a hint prompt 422 using the one or more return values 428. For example, if the chatbot system 300 called a map service, the 300 uses the physical location and information about the physical location returned by the map service to generate the hint prompt 422. In some examples, if the chatbot system 300 called a service or feature of the interactive platform that hosts the chatbot system 300, the chatbot system 300 uses the returned data generated by the service or returned information about the feature to generate the hint prompt 422.

In operation 414, the chatbot system 300 communicates the hint prompt 422 to the generative AI model 332.

In operation 418, the chatbot system 300 receives a response 308 from the generative AI model 332.

In operation 420, the chatbot system 300 provides the response 308 to the user 334 via the user system 306.

In some examples, the chatbot system 300 uses a dialogue management component 310 to generate a response 308 using an intent 320. For example, the dialogue management component 310 receives the intent 320 and communicates the intent 320 as a prompt to the generative AI model 332. The generative AI model 332 receives the prompt and generates the response 308. The generative AI model 332 communicates the response 308 to the dialogue management component 310. The dialogue management component 310 receives the response 308 and communicates the response 308 to the response filter component 304 for additional processing. In some examples, the dialogue management component 310 generates the response 308 using a set of additional services 326, such as, but not limited to, an image generation system. The dialogue management component 310 generates a service request 328 using the intent 320 and communicates the service request 328 to the additional service 326. The additional service 326 uses the service request 328 to generate the request response 330 and communicates the request response 330 to the dialogue management component 310. The dialogue management component 310 uses request response 330 to generate the response 308.

In some examples, the chatbot system 300 uses a response filter component 304 (of FIG. 3) to filter a raw response 318 generated by the dialogue management component 310. For example, the dialogue management component 310 communicates the raw response 318 to the response filter component 304 and the response filter component 304 filters the raw response 318 based on a set of filtering criteria to eliminate specified content from the raw response 318, for instance obscene words or concepts, or content that some may consider harmful. In some examples, the response filter component 304 generates an adjusted intent 322 based on filtering the raw response 318, and the dialogue management component 310 generates an additional raw response 318 using the adjusted intent 322.

In some examples, the generative AI model 332 and the additional service 326 are hosted by the same system that hosts other components of the chatbot system 300. In some examples, the generative AI model 332 and the additional service 326 are hosted by a server system that is separate from the system that hosts the chatbot system 300, and the chatbot system 300 communicates with the generative AI model 332 and the additional service 326 over a network. For example, the chatbot system 300 receives the prompt 302 and communicates the prompt 302 to the generative AI model 332 residing on the separate server system. The generative AI model 332 receives the prompt 302 and generates a raw response 318. The generative AI model 332 then communicates the raw response 318 to the chatbot system 300. The chatbot system 300 receives the response for subsequent processing as described herein.

In some examples, as part of the response 308, the chatbot system 300 generates a set of personal AI system prompts that are displayed to the user 334 by the user system 306 that prompt the user 334 to interact with the chatbot system 300. The personal AI system prompts generated by the chatbot system 300 may include chat information such as, but not limited to, context sensitive material, instructions to the user 334, possible topics of conversation, and the like. In some examples, the chatbot system 300 uses the personal AI system prompts to suggest chat topics to a user 334 or to guide the user 334 through a conversation, such as providing instructional material on various topics. In some examples, the personal AI system prompts comprise suggestions of conversations or questions that are intended to solicit a user 334 to enter a prompt of the user 334. The suggested chats are aimed at helping the user 334 get to information they need, but provide a helpful side effect of generating additional user interactions with the chatbot system 300. These additional user interactions improve the ability of the chatbot system 300 determine user intent by provided additional context and information to the chatbot system 300.

In some examples, the system that hosts the chatbot system 300 may not be a component of an interactive platform but another interaction system that provides services and information to a group of users such as, but not limited to, a platform that provides enterprise wide connectivity to a group of users such as employees of a company, clients of an enterprise provided professional services, educational institutions, and the like. In some of such examples, the content provided to the users may not be advertising, but may be other types of useful information such as company policies, status messages for projects, newsworthy events, and the like.

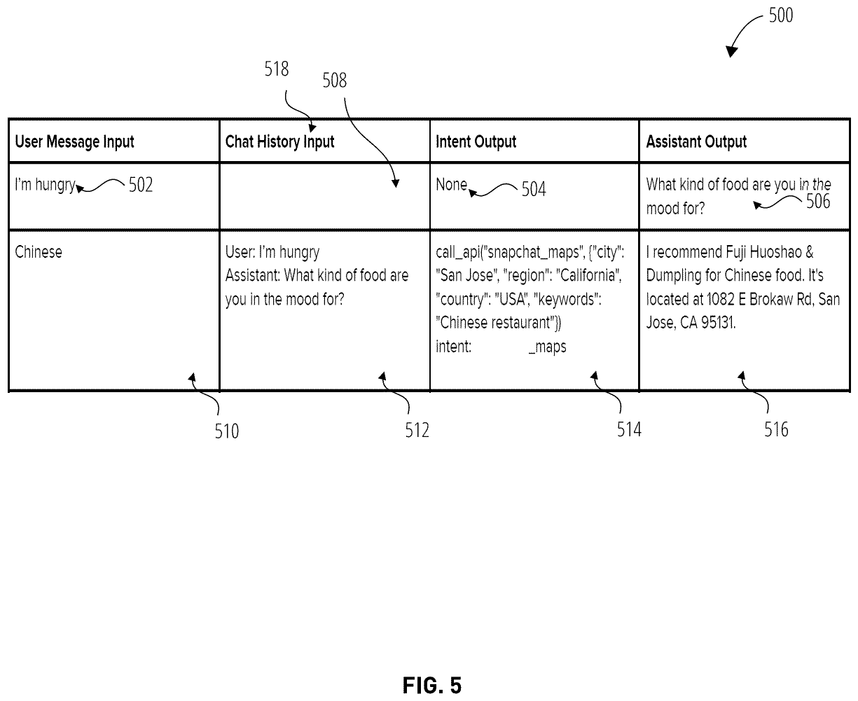

FIG. 5 is an illustration of a chat session between a user and a chatbot, in accordance with some examples. To initiate the chat session 500, a user, such as user 334 (of FIG. 3), communicates an initial prompt 502 to a chatbot system, such as chatbot system 300 (of FIG. 3). At the initiation of the chat session 500, a chat history 518 is an empty chat history 508. The initial prompt 502 is a declarative statement by the user that is not relevant the chatbot system 300, the chat history 518, or the interactive platform hosting the chatbot system 300, so the chatbot system 300 makes an initial intent determination 504 of “none”. Accordingly, the chatbot system 300 communicates the initial prompt 502 to a generative AI model, such as generative AI model 332 (of FIG. 3) as a personality prompt. The generative AI model 332 responds with a personality response 506 that prompts the user for an additional user prompt. The user responds with a prompt 510 that contains a keyword “Chinese” that is relevant to the chat history with keywords 512 related to food. The chatbot system 300 determines a user intent, namely an intent to cat a particular kind of food. In response, the chatbot system 300 determines one or more API calls to additional services 514 such as a map service with arguments that were determined from the chat history with keywords 512, a physical location of the user 334 as determined from a user profile and the interactive platform hosting the chatbot system 300. The chatbot system 300 receives return values from the additional services 326 (of FIG. 3) and generates a hint prompt using the return values and communicates the hint prompt to the generative AI model 332. The generative AI model responds with a hint-based response 516 that indicates an establishment close to the user 334 where the user 334 can procure the type of food that they want.

### Machine-Learning Pipeline

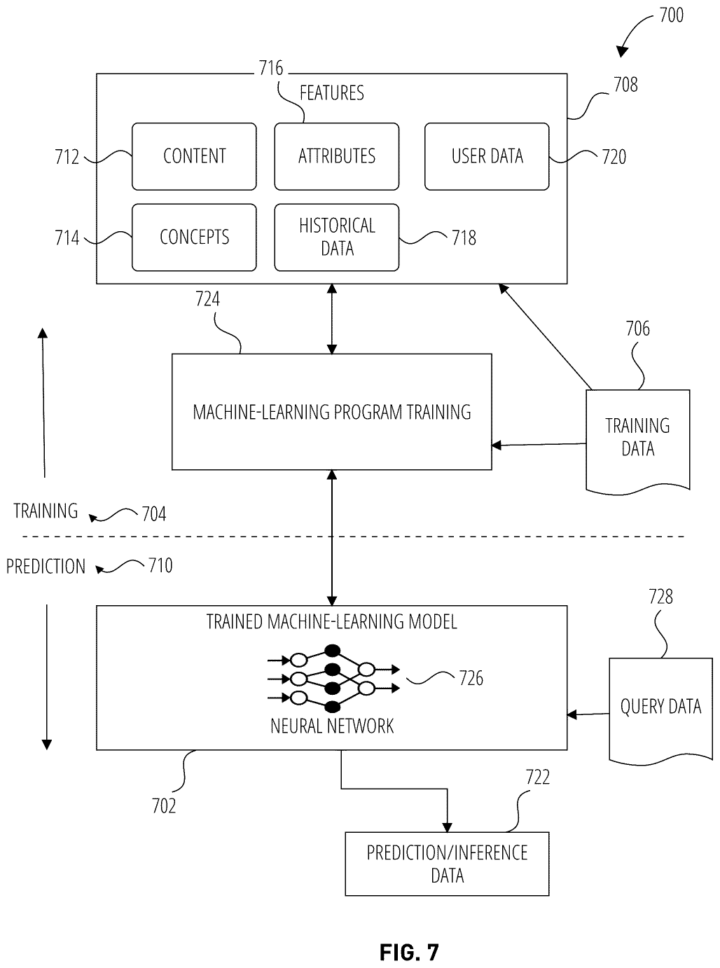

FIG. 7 is a flowchart depicting a machine-learning pipeline 700, according to some examples. The machine-learning pipeline 700 may be used to generate a trained machine-learning model 702 used, for example, to perform operations associated with components of a chatbot system (of FIG. 3) such as an NLU component 312, a generative AI model 332, a dialogue management component 310, a response filter component 304, and the like.

### Overview

Broadly, machine learning may involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Three example types of problems in machine learning are classification problems, regression problems, and generation problems. Classification problems, also referred to as categorization problems, aim at classifying items into one of several category values (for example, is this object an apple or an orange?). Regression algorithms aim at quantifying some items (for example, by providing a value that is a real number). Generation algorithms aim at producing new examples that are similar to examples provided for training. For instance, a text generation algorithm is trained on many text documents and is configured to generate new coherent text with similar statistical properties as the training data.

### Training Phases

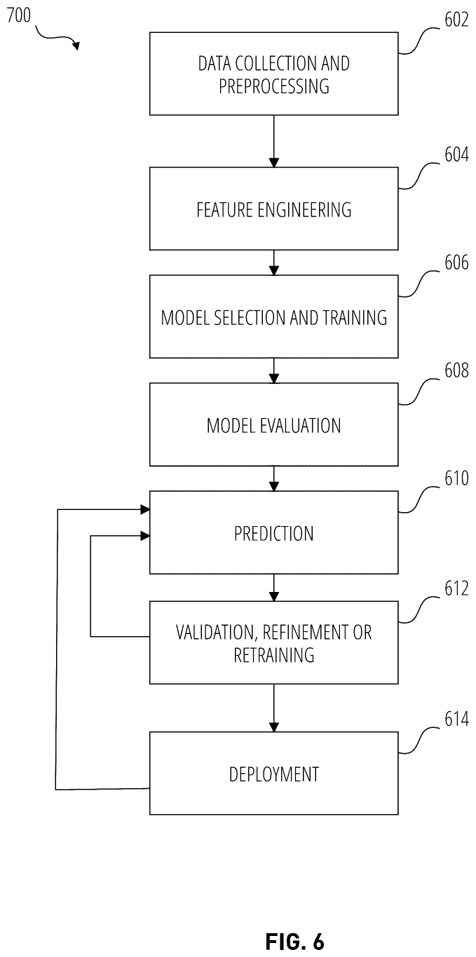

Generating a trained machine-learning model 702 may include multiple phases that form part of the machine-learning pipeline 700, including for example the following phases illustrated in FIG. 6:
Data collection and preprocessing 602: This phase may include acquiring and cleaning data to ensure that it is suitable for use in the machine learning model. This phase may also include removing duplicates, handling missing values, and converting data into a suitable format.
Feature engineering 604: This phase may include selecting and transforming the training data 706 to create features that are useful for predicting the target variable. Feature engineering may include (1) receiving features 708 (e.g., as structured or labeled data in supervised learning) and/or (2) identifying features 708 (e.g., unstructured or unlabeled data for unsupervised learning) in training data 706.
Model selection and training 606: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 608: This phase may include evaluating the performance of a trained model (e.g., the trained machine-learning model 702) on a separate testing dataset. This phase can help determine if the model is overfitting or underfitting and determine whether the model is suitable for deployment.
Prediction 610: This phase involves using a trained model (e.g., trained machine-learning model 702) to generate predictions on new, unseen data.
Validation, refinement or retraining 612: This phase may include updating a model based on feedback generated from the prediction phase, such as new data or user feedback.
Deployment 614: This phase may include integrating the trained model (e.g., the trained machine-learning model 702) into a more extensive system or application, such as a web service, mobile app, or IoT device. This phase can involve setting up APIs, building a user interface, and ensuring that the model is scalable and can handle large volumes of data.

In some examples, training data of a model of the NLU component 312 includes:
Intent labeled data: Sentences and phrases labeled with the intent they map to, such as “find a restaurant”→intent=find_restaurant. This helps the model learn intent classification.
Entity labeled data: Sentences and phrases with entity annotations, like “Make me a reservation at [restaurant_name]”. This teaches the model to extract entities.
Dialogue datasets: Conversational datasets with dialogue history and labeled intents/entities. This provides context for intent understanding.
Keyword labeled data: Sentences annotated with related keywords and concepts. This allows keyword extraction for determining intent.
Platform interaction data: Real user prompts and responses from the interactive platform. This teaches platform-specific language.
Synthetic variations: Artificially generated variations of real user prompts. This improves generalization.
Multimodal data: Prompts with associated images, audio, video etc. This allows understanding multimodal intents.
User profile data: Prompts correlated with user profile information like demographics, preferences. This provides personalization.
External knowledge sources: Relevant data from non-conversational sources like search queries, Wikipedia, books. This gives world knowledge.

In some examples, the model used by the NLU component 312 is pretrained on large generic dialogue datasets and then fine-tuned on platform-specific prompts labeled for intents, entities, keywords, and the like.

In some examples, data used to train the dialogue management component 310 includes:
Intent-response pairs: Mapping of intents to possible responses, like intent=find_restaurant→“Here are some restaurant options . . . ”. This teaches intent-based response generation.
Dialogue datasets: Conversational datasets with dialogue turns labeled with intents and responses. Provides context for natural conversations.
Response labeled data: Utterances labeled with the appropriate response, like “I'm hungry”→ “Here are some restaurants nearby”. Teaches general response generation.
Persona datasets: Dialogues containing consistent persona styles, for learning personalized responses.
Multimodal data: Text prompts aligned with media like images, audio, etc. and corresponding responses. Allows generating multimodal responses.
External knowledge: Relevant structured data like restaurant databases, weather data etc. that can inform responses.
User profile data: Personal info like cuisine preferences, dietary needs etc. for personalized responses.
Reinforcement learning data: Dialogue simulations with rewards for coherent, relevant responses. Allows optimizing response quality.
Real user interactions: Logs of real user prompts and bot responses from the platform. Provides grounding in natural conversations.

In some examples the model used by the dialogue management component 310 is pre-trained on large conversational datasets and fine-tuned using platform dialogues and persona/profile data.

In some example, data used to train a model used by the response filter component 304 includes:
Abusive language datasets: Sentences labeled as abusive or not, like “You're an*****”→abusive. Teaches the model to detect abusive language.
Harmful content datasets: Text labeled with different types of harmful content it contains. Allows recognizing threats, hate speech, and the like.
Offensive language datasets: Text annotated with offensiveness scores. Enables quantifying degree of offensiveness.
Toxicity datasets: Comments labeled as toxic or not. Helps identify generally toxic language.
Hate speech datasets: Text annotated for racism, sexism, homophobia, and the like. Allows detecting different forms of hate speech.
Cyberbullying datasets: Social media posts labeled as cyberbullying or not. Useful for identifying bullying.
Profanity datasets: Sentences marked with profane words. Allows recognizing profanity.
Platform data: Real examples of harmful messages on the platform. Provides platform-specific grounding.
Multimodal data: Text aligned with images, audio, video, etc. Allows understanding multimodal offensiveness.
Context data: Conversations with situational/demographic context. Helps account for contextual offensiveness.

In some examples, the model used by the response filter component 304 can be pre-trained on large corpora of labeled offensive/abusive data and fine-tuned using platform data to recognize platform-specific policy violations.

In some examples, data used to train the generative AI model 332 includes:
Dialogue datasets: Large conversational datasets containing examples of natural conversations, questions and answers, etc. Teaches conversational language.
Text corpora: Large general text datasets like news articles, web pages, books, etc. Provides broad linguistic grounding.
Multimodal data: Text aligned with images, audio, videos, etc. Allows generating multimodal responses.
Persona datasets: Dialogues with consistent personality and styles. Enables adopting different personas.
Story/narrative data: Coherent stories and anecdotes. Helps generate coherent, relevant responses.
Knowledge bases: Structured data like restaurant info, weather data, etc. Informs factual responses.
User profiles: Personal info like interests, preferences, etc. Allows personalization.
Platform data: Real user prompts and responses from the platform. Grounds model in platform style.
Reinforcement learning data: Conversations with coherence rewards. Optimizes response relevance.
Synthetic variations: Artificial recombinations and perturbations of real data. Improves generalization.

In some examples, the generative AI model 332 is pre-trained on large unlabeled corpora, fine-tuned on conversational data, and optimized for coherence and relevance using reinforcement learning. In some examples, the generative AI model 332 is fine-tuned using platform data and user feedback to enhance response quality over time.

FIG. 7 illustrates further details of two example phases, namely a training phase 704 (e.g., part of the model selection and trainings 606) and a prediction phase 710 (part of prediction 610). Prior to the training phase 704, feature engineering 604 is used to identify features 708. This may include identifying informative, discriminating, and independent features for effectively operating the trained machine-learning model 702 in pattern recognition, classification, and regression. In some examples, the training data 706 includes labeled data, known for pre-identified features 708 and one or more outcomes. Each of the features 708 may be a variable or attribute, such as an individual measurable property of a process, article, system, or phenomenon represented by a data set (e.g., the training data 706). Features 708 may also be of different types, such as numeric features, strings, and graphs, and may include one or more of content 712, concepts 714, attributes 716, historical data 718, and/or user data 720, merely for example.

In training phase 704, the machine-learning pipeline 700 uses the training data 706 to find correlations among the features 708 that affect a predicted outcome or prediction/inference data 722.

With the training data 706 and the identified features 708, the trained machine-learning model 702 is trained during the training phase 704 during machine-learning program training 724. The machine-learning program training 724 appraises values of the features 708 as they correlate to the training data 706. The result of the training is the trained machine-learning model 702 (e.g., a trained or learned model).

Further, the training phase 704 may involve machine learning, in which the training data 706 is structured (e.g., labeled during preprocessing operations). The trained machine-learning model 702 implements a neural network 726 capable of performing, for example, classification and clustering operations. In other examples, the training phase 704 may involve deep learning, in which the training data 706 is unstructured, and the trained machine-learning model 702 implements a deep neural network 726 that can perform both feature extraction and classification/clustering operations.

In some examples, a neural network 726 may be generated during the training phase 704, and implemented within the trained machine-learning model 702. The neural network 726 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 726 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 726 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 704, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 710, the trained machine-learning model 702 uses the features 708 for analyzing query data 728 to generate inferences, outcomes, or predictions, as examples of a prediction/inference data 722. For example, during prediction phase 710, the trained machine-learning model 702 generates an output. Query data 728 is provided as an input to the trained machine-learning model 702, and the trained machine-learning model 702 generates the prediction/inference data 722 as output, responsive to receipt of the query data 728.

In some examples, the trained machine-learning model 702 may be a generative AI model. Generative AI is a term that may refer to any type of artificial intelligence that can create new content from training data 706. For example, generative AI can produce text, images, video, audio, code, or synthetic data similar to the original data but not identical. Some of the techniques that may be used in generative AI are:
Convolutional Neural Networks (CNNs): CNNs may be used for image recognition and computer vision tasks. CNNs may, for example, be designed to extract features from images by using filters or kernels that scan the input image and highlight important patterns.
Recurrent Neural Networks (RNNs): RNNs may be used for processing sequential data, such as speech, text, and time series data, for example. RNNs employ feedback loops that allow them to capture temporal dependencies and remember past inputs.
Generative adversarial networks (GANs): GANs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.

In generative AI examples, the query data 728 may include text, audio, image, video, numeric, or media content prompts and the output prediction/inference data 722 includes text, images, video, audio, code, or synthetic data.

### Data Architecture

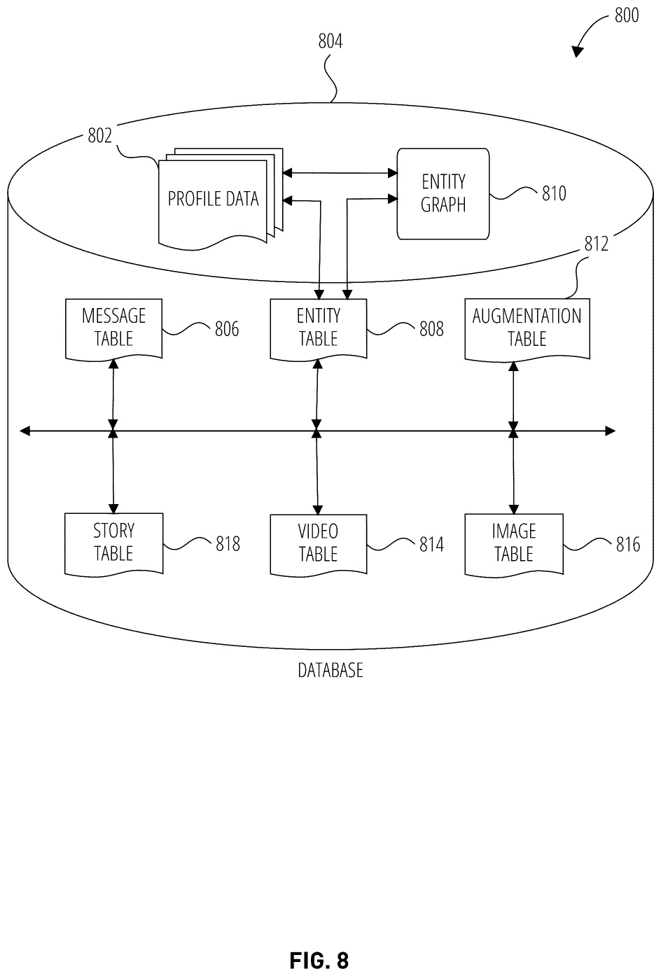

FIG. 8 is a schematic diagram illustrating data structures 800, which may be stored in the database 804 of the interactive server system 110, according to certain examples. While the content of the database 804 is shown to comprise multiple tables, it will be appreciated that the data could be stored in other types of data structures (e.g., as an object-oriented database).

The database 804 includes message data stored within a message table 806. This message data includes, for any particular message, at least message sender data, message recipient (or receiver) data, and a payload. Further details regarding information that may be included in a message, and included within the message data stored in the message table 806, are described below with reference to FIG. 8.

An entity table 808 stores entity data, and is linked (e.g., referentially) to an entity graph 810 and profile data 802. Entities for which records are maintained within the entity table 808 may include individuals, corporate entities, organizations, objects, places, events, and so forth. Regardless of entity type, any entity regarding which the interactive server system 110 stores data may be a recognized entity. Each entity is provided with a unique identifier, as well as an entity type identifier (not shown).

The entity graph 810 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interactive platform 100.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 808. Such privacy settings may be applied to all types of relationships within the context of the interactive platform 100, or may selectively be applied to only certain types of relationships.

The profile data 802 stores multiple types of profile data about a particular entity. The profile data 802 may be selectively used and presented to other users of the interactive platform 100 based on privacy settings specified by a particular entity. Where the entity is an individual, the profile data 802 includes, for example, a username, telephone number, address, settings (e.g., notification and privacy settings), as well as a user-selected avatar representation (or collection of such avatar representations). A particular user may then selectively include one or more of these avatar representations within the content of messages communicated via the interactive platform 100, and on map interfaces displayed by interaction clients 104 to other users. The collection of avatar representations may include “status avatars,” which present a graphical representation of a status or activity that the user may select to communicate at a particular time.

Where the entity is a group, the profile data 802 for the group may similarly include one or more avatar representations associated with the group, in addition to the group name, members, and various settings (e.g., notifications) for the relevant group.

The database 804 also stores augmentation data, such as overlays or filters, in an augmentation table 812. The augmentation data is associated with and applied to videos (for which data is stored in a video table 814) and images (for which data is stored in an image table 816).

Filters, in some examples, are overlays that are displayed as overlaid on an image or video during presentation to a message receiver. Filters may be of various types, including user-selected filters from a set of filters presented to a message sender by the interaction client 104 when the message sender is composing a message. Other types of filters include geolocation filters (also known as geo-filters), which may be presented to a message sender based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a message sender by the interaction client 104 based on other inputs or information gathered by the user system 102 during the message creation process. Examples of data filters include current temperature at a specific location, a current speed at which a message sender is traveling, battery life for a user system 102, or the current time.

Other augmentation data that may be stored within the image table 816 includes augmented reality content items (e.g., corresponding to applying Lenses or augmented reality experiences). An augmented reality content item may be a real-time special effect and sound that may be added to an image or a video.

As described above, augmentation data includes augmented reality (AR), virtual reality (VR) and mixed reality (MR) content items, overlays, image transformations, images, and modifications that may be applied to image data (e.g., videos or images). This includes real-time modifications, which modify an image as it is captured using device sensors (e.g., one or multiple cameras) of the user system 102 and then displayed on a screen of the user system 102 with the modifications. This also includes modifications to stored content, such as video clips in a collection or group that may be modified. For example, in a user system 102 with access to multiple augmented reality content items, a user can use a single video clip with multiple augmented reality content items to see how the different augmented reality content items will modify the stored clip. Similarly, real-time video capture may use modifications to show how video images currently being captured by sensors of a user system 102 would modify the captured data. Such data may simply be displayed on the screen and not stored in memory, or the content captured by the device sensors may be recorded and stored in memory with or without the modifications (or both). In some systems, a preview feature can show how different augmented reality content items will look within different windows in a display at the same time. This can, for example, enable multiple windows with different pseudorandom animations to be viewed on a display at the same time.

Data and various systems using augmented reality content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various examples, different methods for achieving such transformations may be used. Some examples may involve generating a three-dimensional mesh model of the object or objects, and using transformations and animated textures of the model within the video to achieve the transformation. In some examples, tracking of points on an object may be used to place an image or texture (which may be two-dimensional or three-dimensional) at the tracked position. In still further examples, neural network analysis of video frames may be used to place images, models, or textures in content (e.g., images or frames of video). Augmented reality content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device, or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of an object's elements, characteristic points for each element of an object are calculated (e.g., using an Active Shape Model (ASM) or other known methods). Then, a mesh based on the characteristic points is generated for each element of the object. This mesh is used in the following stage of tracking the elements of the object in the video stream. In the process of tracking, the mesh for each element is aligned with a position of each element. Then, additional points are generated on the mesh.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification, properties of the mentioned areas can be transformed in different ways. Such modifications may involve changing the color of areas; removing some part of areas from the frames of the video stream; including new objects into areas that are based on a request for modification; and modifying or distorting the elements of an area or object. In various examples, any combination of such modifications or other similar modifications may be used. For certain models to be animated, some characteristic points can be selected as control points to be used in determining the entire state-space of options for the model animation.

In some examples of a computer animation model to transform image data using face detection, the face is detected on an image using a specific face detection algorithm (e.g., Viola-Jones). Then, an Active Shape Model (ASM) algorithm is applied to the face region of an image to detect facial feature reference points.

Other methods and algorithms suitable for face detection can be used. For example, in some examples, features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

A transformation system can capture an image or video stream on a client device (e.g., the user system 102) and perform complex image manipulations locally on the user system 102 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the user system 102.

In some examples, a computer animation model to transform image data can be used by a system where a user may capture an image or video stream of the user (e.g., a selfie) using the user system 102 having a neural network operating as part of an interaction client 104 operating on the user system 102. The transformation system operating within the interaction client 104 determines the presence of a face within the image or video stream and provides modification icons associated with a computer animation model to transform image data, or the computer animation model can be present as associated with an interface described herein. The modification icons include changes that are the basis for modifying the user's face within the image or video stream as part of the modification operation. Once a modification icon is selected, the transform system initiates a process to convert the image of the user to reflect the selected modification icon (e.g., generate a smiling face on the user). A modified image or video stream may be presented in a graphical user interface displayed on the user system 102 as soon as the image or video stream is captured and a specified modification is selected. The transformation system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine-taught neural networks may be used to enable such modifications.

The graphical user interface, presenting the modification performed by the transform system, may supply the user with additional interaction options. Such options may be based on the interface used to initiate the content capture and selection of a particular computer animation model (e.g., initiation from a content creator user interface). In various examples, a modification may be persistent after an initial selection of a modification icon. The user may toggle the modification on or off by tapping or otherwise selecting the face being modified by the transformation system and store it for later viewing or browsing to other areas of the imaging application. Where multiple faces are modified by the transformation system, the user may toggle the modification on or off globally by tapping or selecting a single face modified and displayed within a graphical user interface. In some examples, individual faces, among a group of multiple faces, may be individually modified, or such modifications may be individually toggled by tapping or selecting the individual face or a series of individual faces displayed within the graphical user interface.

A story table 818 stores data regarding collections of messages and associated image, video, or audio data, which are compiled into a collection (e.g., a story or a gallery). The creation of a particular collection may be initiated by a particular user (e.g., each user for which a record is maintained in the entity table 808). A user may create a “personal story” in the form of a collection of content that has been created and sent/broadcast by that user. To this end, the user interface of the interaction client 104 may include an icon that is user-selectable to enable a message sender to add specific content to his or her personal story.

A collection may also constitute a “live story,” which is a collection of content from multiple users that is created manually, automatically, or using a combination of manual and automatic methodologies. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may require a second degree of authentication to verify that the end-user belongs to a specific organization or other entity (e.g., is a student on the university campus).

As mentioned above, the video table 814 stores video data that, in some examples, is associated with messages for which records are maintained within the message table 806. Similarly, the image table 816 stores image data associated with messages for which message data is stored in the entity table 808. The entity table 808 may associate various augmentations from the augmentation table 812 with various images and videos stored in the image table 816 and the video table 814.

The databases 804 also include social network information collected by an interactive platform of an interaction system. The social network information may include without limitation relationship and communication data for users of the interactive platform. The social network information can be used to group two or more users and offer additional functionality of the interactive platform 100. Examples of relationships include, but are not limited to, best friends relationships where two or more users are determined to be mutual best friends based on a frequency of their interactions, users who have common interests in current events, users who share an affiliation through social clubs or philanthropic organizations, and the like. Examples of communications include without limitation chats, private and public messages, exchanges of media such as images, videos, audio recordings, and the like.

### Data Communications Architecture

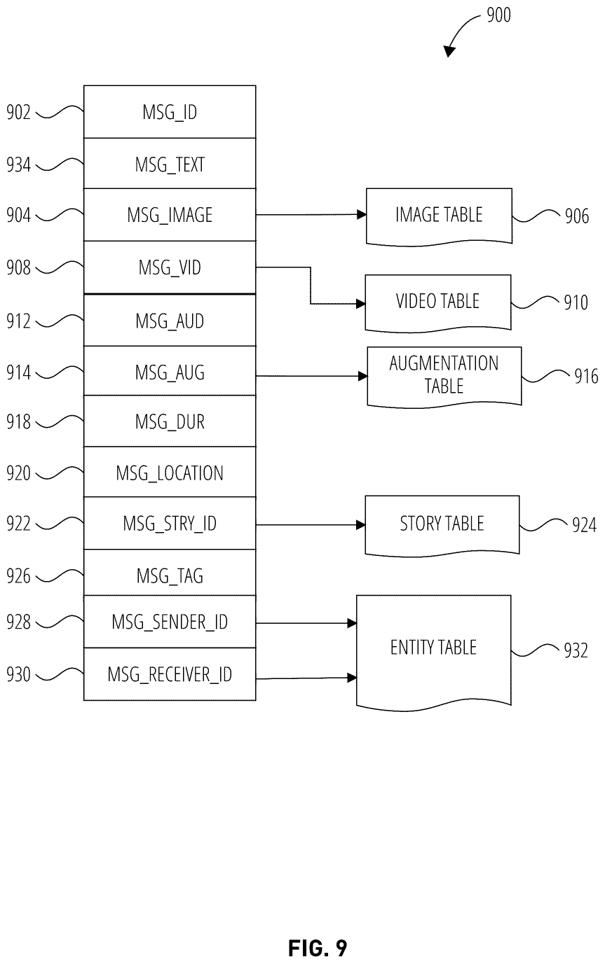

FIG. 9 is a schematic diagram illustrating a structure of a message 900, according to some examples, generated by an interaction client 104 for communication to a further interaction client 104 via the interaction servers 124. The content of a particular message 900 is used to populate the message table 806 stored within the database 804, accessible by the interaction servers 124. Similarly, the content of a message 900 is stored in memory as “in-transit” or “in-flight” data of the user system 102 or the interaction servers 124. A message 900 is shown to include the following example components:
Message identifier 902: a unique identifier that identifies the message 900.
Message text payload 934: text, to be generated by a user via a user interface of the user system 102, and that is included in the message 900.
Message image payload 904: image data, captured by a camera component of a user system 102 or retrieved from a memory component of a user system 102, and that is included in the message 900. Image data for a sent or received message 900 may be stored in the image table 906.
Message video payload 908: video data, captured by a camera component or retrieved from a memory component of the user system 102, and that is included in the message 900. Video data for a sent or received message 900 may be stored in the video table 910.
Message audio payload 912: audio data, captured by a microphone or retrieved from a memory component of the user system 102, and that is included in the message 900.
Message augmentation data 914: augmentation data (e.g., filters, stickers, or other annotations or enhancements) that represents augmentations to be applied to message image payload 904, message video payload 908, or message audio payload 912 of the message 900. Augmentation data for a sent or received message 900 may be stored in the augmentation table 916.
Message duration parameter 918: parameter value indicating, in seconds, the amount of time for which content of the message (e.g., the message image payload 904, message video payload 908, message audio payload 912) is to be presented or made accessible to a user via the interaction client 104.
Message geolocation parameter 920: geolocation data (e.g., latitudinal and longitudinal coordinates) associated with the content payload of the message. Multiple message geolocation parameter 920 values may be included in the payload, each of these parameter values being associated with respect to content items included in the content (e.g., a specific image within the message image payload 904, or a specific video in the message video payload 908).
Message story identifier 922: identifier values identifying one or more content collections (e.g., “stories” identified in the story table 924) with which a particular content item in the message image payload 904 of the message 900 is associated. For example, multiple images within the message image payload 904 may each be associated with multiple content collections using identifier values.
Message tag 926: each message 900 may be tagged with multiple tags, each of which is indicative of the subject matter of content included in the message payload. For example, where a particular image included in the message image payload 904 depicts an animal (e.g., a lion), a tag value may be included within the message tag 926 that is indicative of the relevant animal. Tag values may be generated manually, based on user input, or may be automatically generated using, for example, image recognition.
Message sender identifier 928: an identifier (e.g., a messaging system identifier, email address, or device identifier) indicative of a user of the user system 102 on which the message 900 was generated and from which the message 900 was sent.
Message receiver identifier 930: an identifier (e.g., a messaging system identifier, email address, or device identifier) indicative of a user of the user system 102 to which the message 900 is addressed.

The contents (e.g., values) of the various components of message 900 may be pointers to locations in tables within which content data values are stored. For example, an image value in the message image payload 904 may be a pointer to (or address of) a location within an image table 906. Similarly, values within the message video payload 908 may point to data stored within a video table 910, values stored within the message augmentation data 914 may point to data stored in an augmentation table 916, values stored within the message story identifier 922 may point to data stored in a story table 924, and values stored within the message sender identifier 928 and the message receiver identifier 930 may point to user records stored within an entity table 932.

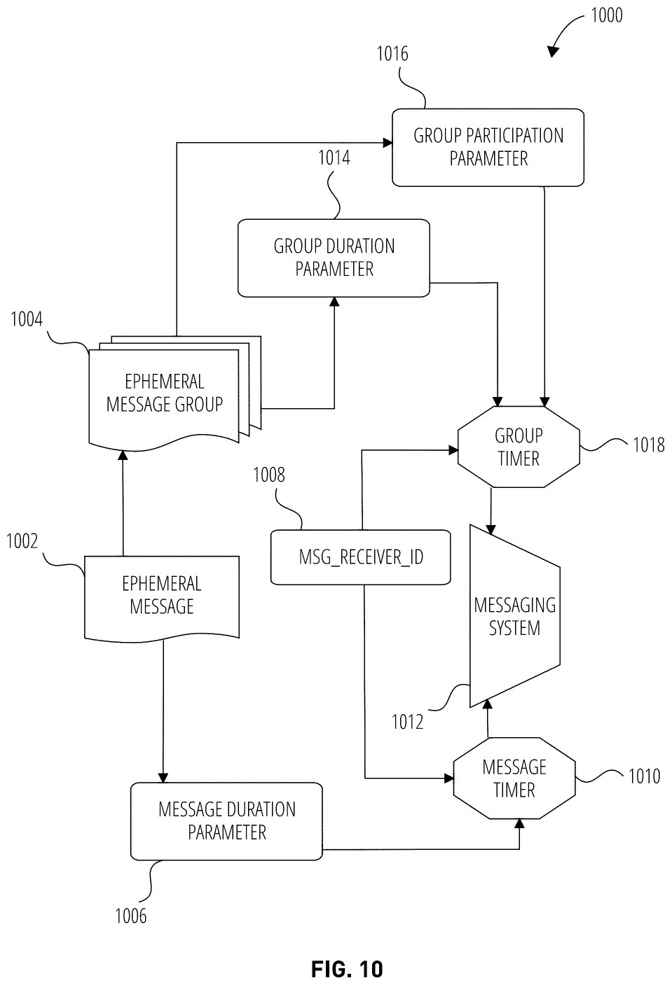

FIG. 10 is a schematic diagram illustrating an access-limiting process 1000, in terms of which access to content (e.g., an ephemeral message 1002 and associated multimedia payload of data) or a content collection (e.g., an ephemeral message group 1004) may be time-limited (e.g., made ephemeral).

An ephemeral message 1002 is shown to be associated with a message duration parameter 1006, the value of which determines the amount of time that the ephemeral message 1002 will be displayed to a receiving user of the ephemeral message 1002 by the interaction client 104. In some examples, an ephemeral message 1002 is viewable by a receiving user for up to a maximum of 10 seconds, depending on the amount of time that the message sender specifies using the message duration parameter 1006.

The message duration parameter 1006 and the message receiver identifier 1008 are shown to be inputs to a message timer 1010, which is responsible for determining the amount of time that the ephemeral message 1002 is shown to a particular receiving user identified by the message receiver identifier 1008. In particular, the ephemeral message 1002 will be shown to the relevant receiving user for a time period determined by the value of the message duration parameter 1006. The message timer 1010 is shown to provide output to a more generalized messaging system 1012, which is responsible for the overall timing of display of content (e.g., an ephemeral message 1002) to a receiving user.

The ephemeral message 1002 is shown in FIG. 10 to be included within an ephemeral message group 1004 (e.g., a collection of messages in a personal story, or an event story). The ephemeral message group 1004 has an associated group duration parameter 1014, a value of which determines a time duration for which the ephemeral message group 1004 is presented and accessible to users of the interactive platform 100. The group duration parameter 1014, for example, may be the duration of a music concert, where the ephemeral message group 1004 is a collection of content pertaining to that concert. Alternatively, a user (either the owning user or a curator user) may specify the value for the group duration parameter 1014 when performing the setup and creation of the ephemeral message group 1004.

Additionally, each ephemeral message 1002 within the ephemeral message group 1004 has an associated group participation parameter 1016, a value of which determines the duration of time for which the ephemeral message 1002 will be accessible within the context of the ephemeral message group 1004. Accordingly, a particular ephemeral message group 1004 may “expire” and become inaccessible within the context of the ephemeral message group 1004 prior to the ephemeral message group 1004 itself expiring in terms of the group duration parameter 1014. The group duration parameter 1014, group participation parameter 1016, and message receiver identifier 1008 each provide input to a group timer 1018, which operationally determines, firstly, whether a particular ephemeral message 1002 of the ephemeral message group 1004 will be displayed to a particular receiving user and, if so, for how long. Note that the ephemeral message group 1004 is also aware of the identity of the particular receiving user as a result of the message receiver identifier 1008.

Accordingly, the group timer 1018 operationally controls the overall lifespan of an associated ephemeral message group 1004 as well as an individual ephemeral message 1002 included in the ephemeral message group 1004. In some examples, each and every ephemeral message 1002 within the ephemeral message group 1004 remains viewable and accessible for a time period specified by the group duration parameter 1014. In a further example, a certain ephemeral message 1002 may expire within the context of ephemeral message group 1004 based on a group participation parameter 1016. Note that a message duration parameter 1006 may still determine the duration of time for which a particular ephemeral message 1002 is displayed to a receiving user, even within the context of the ephemeral message group 1004. Accordingly, the message duration parameter 1006 determines the duration of time that a particular ephemeral message 1002 is displayed to a receiving user regardless of whether the receiving user is viewing that ephemeral message 1002 inside or outside the context of an ephemeral message group 1004.

The messaging system 1012 may furthermore operationally remove a particular ephemeral message 1002 from the ephemeral message group 1004 based on a determination that it has exceeded an associated group participation parameter 1016. For example, when a message sender has established a group participation parameter 1016 of 24 hours from posting, the messaging system 1012 will remove the relevant ephemeral message 1002 from the ephemeral message group 1004 after the specified 24 hours. The messaging system 1012 also operates to remove an ephemeral message group 1004 when either the group participation parameter 1016 for each and every ephemeral message 1002 within the ephemeral message group 1004 has expired, or when the ephemeral message group 1004 itself has expired in terms of the group duration parameter 1014.

In certain use cases, a creator of a particular ephemeral message group 1004 may specify an indefinite group duration parameter 1014. In this case, the expiration of the group participation parameter 1016 for the last remaining ephemeral message 1002 within the ephemeral message group 1004 will determine when the ephemeral message group 1004 itself expires. In this case, a new ephemeral message 1002, added to the ephemeral message group 1004, with a new group participation parameter 1016, effectively extends the life of an ephemeral message group 1004 to equal the value of the group participation parameter 1016.

Responsive to the messaging system 1012 determining that an ephemeral message group 1004 has expired (e.g., is no longer accessible), the messaging system 1012 communicates with the interactive platform 100 (and, for example, specifically the interaction client 104) to cause an indicium (e.g., an icon) associated with the relevant ephemeral message group 1004 to no longer be displayed within a user interface of the interaction client 104. Similarly, when the messaging system 1012 determines that the message duration parameter 1006 for a particular ephemeral message 1002 has expired, the messaging system 1012 causes the interaction client 104 to no longer display an indicium (e.g., an icon or textual identification) associated with the ephemeral message 1002.

### System Architecture

FIG. 11 is a block diagram illustrating further details regarding the interactive platform 100, according to some examples. Specifically, the interactive platform 100 is shown to comprise the interaction client 104 and the interaction servers 124. The interactive platform 100 embodies multiple subsystems, which are supported on the client-side by the interaction client 104 and on the server-side by the interaction servers 124. Example subsystems are discussed below.

An image processing system 1102 provides various functions that enable a user to capture and augment (e.g., augment or otherwise modify or edit) media content associated with a message.

A camera system 1104 includes control software (e.g., in a camera application) that interacts with and controls hardware camera hardware (e.g., directly or via operating system controls) of the user system 102 to modify and augment real-time images captured and displayed via the interaction client 104.

The augmentation system 1106 provides functions related to the generation and publishing of augmentations (e.g., media overlays) for images captured in real-time by cameras of the user system 102 or retrieved from memory of the user system 102. For example, the augmentation system 1106 operatively selects, presents, and displays media overlays (e.g., an image filter or an image lens) to the interaction client 104 for the augmentation of real-time images received via the camera system 1104 or stored images retrieved from memory of a user system 102. These augmentations are selected by the augmentation system 1106 and presented to a user of an interaction client 104, based on a number of inputs and data, such as for example:
Geolocation of the user system 102; and
interactive platform information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 1102 may interact with, and support, the various subsystems of the communication system 1108, such as the messaging system 1110 and the video communication system 1112.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 1102 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 1102 provides a user-based publication platform that enables users to select a geolocation on a map and upload content associated with the selected geolocation. The user may also specify circumstances under which a particular media overlay should be offered to other users. The image processing system 1102 generates a media overlay that includes the uploaded content and associates the uploaded content with the selected geolocation.

The augmentation creation system 1114 supports augmented reality developer platforms and includes an application for content creators (e.g., artists and developers) to create and publish augmentations (e.g., augmented reality experiences) of the interaction client 104. The augmentation creation system 1114 provides a library of built-in features and tools to content creators including, for example custom shaders, tracking technology, and templates.

In some examples, the augmentation creation system 1114 provides a merchant-based publication platform that enables merchants to select a particular augmentation associated with a geolocation via a bidding process. For example, the augmentation creation system 1114 associates a media overlay of the highest bidding merchant with a corresponding geolocation for a predefined amount of time.

A communication system 1108 is responsible for enabling and processing multiple forms of communication and interaction within the interactive platform 100 and includes a messaging system 1110, a personal AI system 1130, an audio communication system 1116, and a video communication system 1112. The messaging system 1110 is responsible for enforcing the temporary or time-limited access to content by the interaction clients 104. The messaging system 1110 incorporates multiple timers within an ephemeral timer system (not shown) that, based on duration and display parameters associated with a message or collection of messages (e.g., a story), selectively enable access (e.g., for presentation and display) to messages and associated content via the interaction client 104. Further details regarding the operation of the ephemeral timer system are provided below. The audio communication system 1116 enables and supports audio communications (e.g., real-time audio chat) between multiple interaction clients 104. Similarly, the video communication system 1112 enables and supports video communications (e.g., real-time video chat) between multiple interaction clients 104. The personal AI system 1130 is responsible for generating responses to prompts received from a user and communicating a response to the prompt.

A user management system 1118 is operationally responsible for the management of user data and profiles, and maintains interactive platform information regarding relationships between users of the interactive platform 100.

A collection management system 1120 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 1120 may also be responsible for publishing an icon that provides notification of a particular collection to the user interface of the interaction client 104. The collection management system 1120 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 1120 employs machine vision (or image recognition technology) and content rules to curate a content collection automatically. In certain examples, compensation may be paid to a user to include user-generated content into a collection. In such cases, the collection management system 1120 operates to automatically make payments to such users to use their content.

A map system 1122 provides various geographic location functions and supports the presentation of map-based media content and messages by the interaction client 104. For example, the map system 1122 enables the display of user icons or avatars (e.g., stored in profile data 802) on a map to indicate a current or past location of “friends” of a user, as well as media content (e.g., collections of messages including photographs and videos) generated by such friends, within the context of a map. For example, a message posted by a user to the interactive platform 100 from a specific geographic location may be displayed within the context of a map at that particular location to “friends” of a specific user on a map interface of the interaction client 104. A user can furthermore share his or her location and status information (e.g., using an appropriate status avatar) with other users of the interactive platform 100 via the interaction client 104, with this location and status information being similarly displayed within the context of a map interface of the interaction client 104 to selected users.

A game system 1124 provides various gaming functions within the context of the interaction client 104. The interaction client 104 provides a game interface providing a list of available games that can be launched by a user within the context of the interaction client 104 and played with other users of the interactive platform 100. The interactive platform 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 1126 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes Application Programming Interfaces (APIs) with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interactive server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A Web ViewJavaScriptBridge running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 1128 operationally enables the purchasing of advertisements by third parties for presentation to end-users via the interaction clients 104 and also handles the delivery and presentation of these advertisements.

### Software Architecture

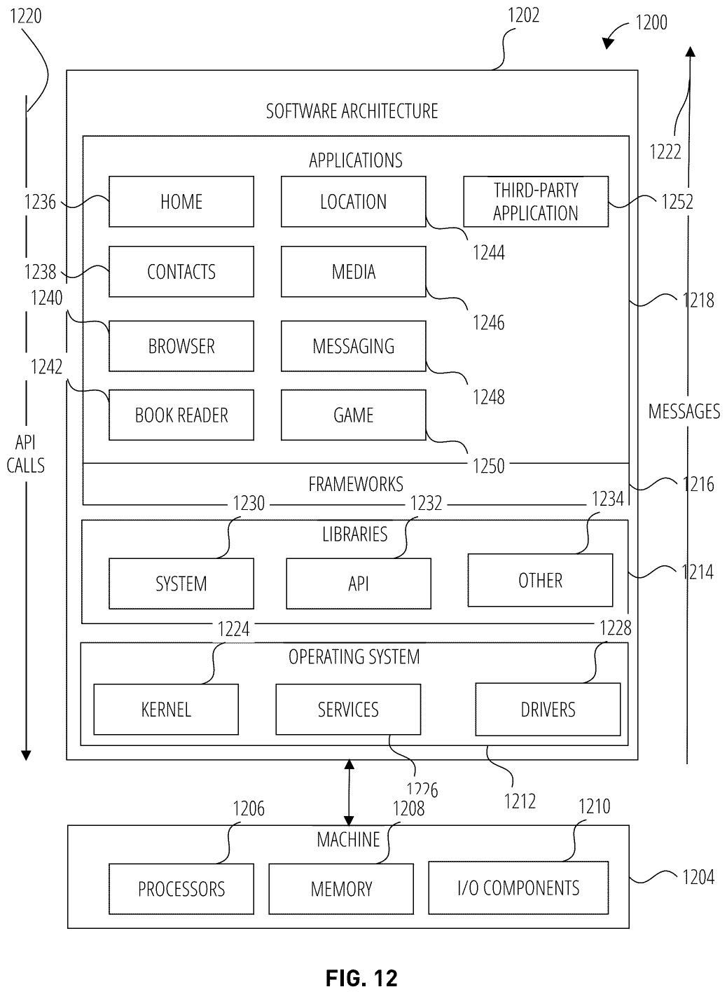

FIG. 12 is a block diagram 1200 illustrating a software architecture 1202, which can be installed on any one or more of the devices described herein. The software architecture 1202 is supported by hardware such as a machine 1204 that includes processors 1206, memory 1208, and I/O components 1210. In this example, the software architecture 1202 can be conceptualized as a stack of layers, where each layer provides a particular functionality. The software architecture 1202 includes layers such as an operating system 1212, libraries 1214, frameworks 1216, and applications 1218. Operationally, the applications 1218 invoke API calls 1220 through the software stack and receive messages 1222 in response to the API calls 1220.

The operating system 1212 manages hardware resources and provides common services. The operating system 1212 includes, for example, a kernel 1224, services 1226, and drivers 1228. The kernel 1224 acts as an abstraction layer between the hardware and the other software layers. For example, the kernel 1224 provides memory management, processor management (e.g., scheduling), component management, networking, and security settings, among other functionalities. The services 1226 can provide other common services for the other software layers. The drivers 1228 are responsible for controlling or interfacing with the underlying hardware. For instance, the drivers 1228 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1214 provide a common low-level infrastructure used by the applications 1218. The libraries 1214 can include system libraries 1230 (e.g., C standard library) that provide functions such as memory allocation functions, string manipulation functions, mathematic functions, and the like. In addition, the libraries 1214 can include API libraries 1232 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1214 can also include a wide variety of other libraries 1234 to provide many other APIs to the applications 1218.

The frameworks 1216 provide a common high-level infrastructure that is used by the applications 1218. For example, the frameworks 1216 provide various graphical user interface (GUI) functions, high-level resource management, and high-level location services. The frameworks 1216 can provide a broad spectrum of other APIs that can be used by the applications 1218, some of which may be specific to a particular operating system or platform.

In an example, the applications 1218 may include a home application 1236, a contacts application 1238, a browser application 1240, a book reader application 1242, a location application 1244, a media application 1246, a messaging application 1248, a game application 1250, and a broad assortment of other applications such as a third-party application 1252. The applications 1218 are programs that execute functions defined in the programs. Various programming languages can be employed to create one or more of the applications 1218, structured in a variety of manners, such as object-oriented programming languages (e.g., Objective-C, Java, or C++) or procedural programming languages (e.g., C or assembly language). In a specific example, the third-party application 1252 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1252 can invoke the API calls 1220 provided by the operating system 1212 to facilitate functionalities described herein.

### Additional Examples Include

Example 1 is a method of an interactive platform, the method comprising: receiving, by one or more processors, from a user system, a prompt of a user during an interactive session, the prompt in a form of a post to an interactive platform; determining, by the one or more processors, a type of the prompt of the user; in response to determining the type of the prompt of the user is a personality prompt, performing, by the one or more processors, operations comprising: generating a personality prompt using the prompt of the user; and communicating the personality prompt to a generative AI model; in response to determining the type of the prompt of the user is an intent prompt, performing, by the one or more processors, operations comprising: generating a hint prompt using an intent determined from the prompt of the user; and communicating the hint prompt to the generative AI model; receiving, by the one or more processors, from the generative AI model a response; and providing, by the one or more processors, the response to the user.

In Example 2, the subject matter of Example 1 includes, wherein generating the hint prompt comprises: generating one or more API calls to one or more services of the interactive platform using the intent determined from the prompt of the user; receiving one or more result values from the one or more services; and generating the hint prompt using the one or more result values.

In Example 3, the subject matter of any of Example 1-2 includes, wherein the prompt of the user comprises at least one of audio media, image media, video media, or textual media.

In Example 4, the subject matter of Examples 1-3 includes, wherein the intent is determined further using a user profile of the user.

In Example 5, the subject matter of Examples 1-4 includes, wherein the intent is determined further using a chat session history of the user.

In Example 6, the subject matter of Examples 1-5 includes, wherein the generative AI model is hosted by the interactive platform.

In Example 7, the subject matter of Examples 1-6 includes, wherein the generative AI model is hosted by system external to the interactive platform.

Example 8 is at least one machine-readable medium including instructions that, when executed by processing circuitry, cause the processing circuitry to perform operations to implement of any of Examples 1-7.

Example 9 is an apparatus comprising means to implement of any of Examples 1-7.

Example 10 is a system to implement of any of Examples 1-7.

Example 11 is a method to implement of any of Examples 1-7.

### Conclusion

Changes and modifications may be made to the disclosed examples without departing from the scope of the present disclosure. These and other changes or modifications are intended to be included within the scope of the present disclosure.

### Glossary

“Carrier signal” refers to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Machine-readable storage medium” refers to both machine-storage media and transmission media. Thus, the terms include both storage devices/media and carrier waves/modulated data signals. The terms “computer-readable medium,” “machine-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory machine-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

In this disclosure and appended claims, the terms “a” or “an” are used, as is common in patent documents, to include one or more than one, independent of any other instances or usages of “at least one” or “one or more.” In this disclosure and appended claims, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the appended claims, the terms “including” and “comprising” are open-ended; that is, a system, device, article, or process that includes elements in addition to those listed after such a term in a claim is still deemed to fall within the scope of that claim.

1. A method of an interactive platform, the method comprising:
receiving, by one or more processors, from a user system, a prompt of a user during an interactive session, the prompt in a form of a post to an interactive platform;
determining, by the one or more processors, a type of the prompt of the user;
in response to determining the type of the prompt of the user is a personality prompt, performing, by the one or more processors, operations comprising:
generating a personality prompt using the prompt of the user; and
communicating the personality prompt to a generative AI model;
in response to determining the type of the prompt of the user is an intent prompt, performing, by the one or more processors, operations comprising:
generating a hint prompt using an intent determined from the prompt of the user; and
communicating the hint prompt to the generative AI model;
receiving, by the one or more processors, from the generative AI model a response; and
providing, by the one or more processors, the response to the user.

2. The method of claim 1, wherein generating the hint prompt comprises:
generating one or more API calls to one or more services of the interactive platform using the intent determined from the prompt of the user;
receiving one or more result values from the one or more services; and
generating the hint prompt using the one or more result values.

3. The method of claim 2, wherein the prompt of the user comprises at least one of audio media, image media, video media, or textual media.

4. The method of claim 1, wherein the intent is determined further using a user profile of the user.

5. The method of claim 2, wherein the intent is determined further using a chat session history of the user.

6. The method of claim 2, wherein the generative AI model is hosted by the interactive platform.

7. The method of claim 1, wherein the generative AI model is hosted by system external to the interactive platform.

8. A machine, comprising:
one or more processors; and
a memory storing instructions that, when executed by the one or more processors, cause the machine to perform operations comprising:
receiving, from a user system, a prompt of a user during an interactive session, the prompt in a form of a post to an interactive platform;
determining a type of the prompt of the user;
in response to determining the type of the prompt of the user is a personality prompt, performing operations comprising:
generating a personality prompt using the prompt of the user; and
communicating the personality prompt to a generative AI model;
in response to determining the type of the prompt of the user is an intent prompt, performing operations comprising:
generating a hint prompt using an intent determined from the prompt of the user; and
communicating the hint prompt to the generative AI model;
receiving, from the generative AI model, a response; and
providing the response to the user.

9. The machine of claim 8, wherein generating the hint prompt comprises:
generating one or more API calls to one or more services of the interactive platform using the intent determined from the prompt of the user;
receiving one or more result values from the one or more services; and
generating the hint prompt using the one or more result values.

10. The machine of claim 9, wherein the prompt of the user comprises at least one of audio media, image media, video media, or textual media.

11. The machine of claim 8, wherein the intent is determined further using a user profile of the user.

12. The machine of claim 9, wherein the intent is determined further using a chat session history of the user.

13. The machine of claim 9, wherein the generative AI model is hosted by the interactive platform.

14. The machine of claim 8, wherein the generative AI model is hosted by system external to the interactive platform.

15. A machine-readable medium storing executable instructions that, when executed by a machine, cause the machine to perform operations comprising:
receiving, from a user system, a prompt of a user during an interactive session, the prompt in a form of a post to an interactive platform;
determining a type of the prompt of the user;
in response to determining the type of the prompt of the user is a personality prompt, performing operations comprising:
generating a personality prompt using the prompt of the user; and
communicating the personality prompt to a generative AI model;
in response to determining the type of the prompt of the user is an intent prompt, performing operations comprising:
generating a hint prompt using an intent determined from the prompt of the user; and
communicating the hint prompt to the generative AI model;
receiving from the generative AI model, a response; and
providing the response to the user.

16. The machine-readable medium of claim 15, wherein generating the hint prompt comprises:
generating one or more API calls to one or more services of the interactive platform using the intent determined from the prompt of the user;
receiving one or more result values from the one or more services; and
generating the hint prompt using the one or more result values.

17. The machine-readable medium of claim 16, wherein the prompt of the user comprises at least one of audio media, image media, video media, or textual media.

18. The machine-readable medium of claim 15, wherein the intent is determined further using a user profile of the user.

19. The machine-readable medium of claim 16, wherein the intent is determined further using a chat session history of the user.

20. The machine-readable medium of claim 16, wherein the generative AI model is hosted by the interactive platform.

21. The machine-readable medium of claim 15, wherein the generative AI model is hosted by system external to the interactive platform.
